(19) United States
(12) Patent Application Publication
(10) Pub. No.: US 2025/0316119 A1
(43) Pub. Date: Oct. 9, 2025

(54) RETROFIT NETWORK-CONTROLLED BICYCLE LOCK SYSTEM FOR SECURING BICYCLES TO RACKS

(71) Applicants: Michael Burton, Bentonville, AR (US); Clayton Woodruff, Bentonville, AR (US)

(72) Inventors: Michael Burton, Bentonville, AR (US); Clayton Woodruff, Bentonville, AR (US)

(21) Appl. No.: 18/629,285

(22) Filed: Apr. 8, 2024

(51) Int. Cl. G07C 9/00; G06K 7/14; G06Q 30/0251; G07C 9/27

(52) U.S. Cl. CPC G07C 9/00182; G06K 7/1417; G06Q 30/0261; G06Q 30/0267; G07C 9/27

(57) ABSTRACT

The present disclosure includes a network-controlled bicycle lock system for securing a bicycle to a bicycle rack. The system includes a retrofit unit designed to attach a lock housing to the bicycle rack, along with a tethering device that connects the bicycle to the lock housing. This innovative design provides a secure and convenient solution for safeguarding bicycles against theft while parked at bicycle racks. The retrofit unit ensures easy installation on existing bicycle racks, while the tethering device offers a reliable means of securing the bicycle to the lock housing. This network-controlled bicycle lock system offers enhanced security and peace of mind for bicycle owners, making it an ideal choice for urban environments and public spaces.

### CROSS-REFERENCES TO RELATED APPLICATIONS

This application claims priority to U.S. Provisional Patent Application No. 63/494,866 Filed Apr. 7, 2023, entitles “UNIVERSAL NETWORK CONTROLLED LOCK,” the entire disclosure which is hereby incorporated by reference, for all purposes, as if fully set forth herein.

### TECHNICAL FIELD

The present disclosure relates to securing bicycles to fixed structures in public locations.

### BACKGROUND

Various approaches have been developed for securing bicycles to bicycle racks, including traditional lock and key mechanisms, combination locks, and electronic locking systems. These conventional bicycle locks typically involve a lock housing that is attached to the bicycle rack and a locking mechanism that secures the bicycle to the lock housing. While these systems provide a level of security, they often lack versatility and ease of use, requiring separate components for locking and unlocking the bicycle.

In some instances, bicycle locks have incorporated tethering devices to physically connect the bicycle to the lock housing, providing an additional layer of security against theft. These tethering devices may include cables, chains, or other flexible materials that can be looped around the bicycle frame or wheels and secured to the lock housing. However, existing tethering devices may be cumbersome to use, prone to tangling, or susceptible to damage from cutting tools, compromising the overall security of the bicycle lock system.

Furthermore, current bicycle lock designs may not be easily adaptable to different types of bicycle racks or may require specialized installation procedures, limiting their practicality and widespread adoption. While efforts have been made to improve the security and convenience of bicycle locks, there remains a need for a versatile and user-friendly bicycle lock system that can be easily retrofitted to various bicycle racks while providing robust protection against theft. However, none of these approaches have provided a comprehensive solution that combines the features described in this disclosure.

### SUMMARY

Embodiments of the present disclosure relate to a bike security system or network-controlled bicycle lock which offers a cutting-edge solution for bike owners seeking a secure and convenient way to lock their bikes. The network-controlled bicycle lock is configurable to retrofit existing bike racks and features a tamper-resistant housing that protects the electrical components from inclement weather and vandalism. The network-controlled bicycle lock can be application-enabled, and can feature a sleeved chain from a housing, wherein the sleeved chain is highly resistant to cutting and tampering, ensuring maximum security for the bike owner. The network-controlled bicycle lock can incorporate a universal mounting bracket, a solar panel and battery reserve for power, and an app-less entry feature that allows users to lock and unlock their bikes without having to install a network-connected application on their smartphones. Furthermore, the network-controlled bicycle lock system can include an audible alarm on the rack, which sounds if tampering is detected; a video display for a user interface to denote the lock status, time remaining, to deliver one or more geo-target or proximity-based and time-conditioned advertisements and a push notification system that alerts the user's cell phone if tampering is detected, enabling a user to take immediate action and prevent theft.

The network-controlled bicycle locks provided herein are electromechanical devices that may be locked or unlocked in a purely mechanical fashion, while it is also contemplated that the devices may be locked or unlocked via electronic command received via a wireless protocol, such as Wi-Fi, Bluetooth, or near field communication (NFC), and/or other radio frequency (RF) or wireless protocol, via a mobile device. The network-controlled bicycle lock may then be connected with a wireless communications hub, which may connect to a larger network, such as the internet. Such as configuration allows a user to control lock/unlock access of the bicycle lock remotely using the mobile device.

In some aspects, the techniques described herein relate to a network-controlled bicycle lock 100, wherein the lock housing includes a housing surface of hard, rigid material, and a housing interior configured to communicate to the housing surface via a lock aperture configured to receive at least a portion of the tethering device.

In some aspects, the techniques described herein relate to a method of using a network-controlled lock including: Providing a network-controlled bicycle lock including: retrofit unit, configured to fasten a lock housing to a bicycle rack, a tethering device configured to communicate a bicycle to the lock housing that has a communication transmitter; providing a user, a user's smartphone, and a smartphone application configured to configured to communicate with the user's smartphone including shareable location data, network connection, and a camera; providing a wireless network configured to communicate with the network-controlled bicycle lock and the user's smartphone; sending a notification to the user's smartphone via the network connection to alert the user their proximity to the network-controlled lock; scanning the network-controlled lock with the camera; providing a user credential to the network-controlled lock via the smartphone application configured lock and unlock the network-controlled lock; unlocking the network-controlled lock via the user credential delivered to the network-controlled lock; and locking the network-controlled lock via the user credential delivered to the network-controlled lock.

In some aspects, the techniques described herein relate to a method further including: providing the communication transmitter that further includes a QR code; scanning the QR code on the communication transmitter with the camera; providing a network-connected application configured to communicate over the wireless network, wherein the network-connected application communicates with the network-controlled lock, selecting the network-controlled lock on the network-connected application via the user's smartphone, and connecting the user's smartphone to the network-controlled lock via the network connection.

It is also contemplated, that according some embodiments disclosed herein, the network-controlled bicycle lock (or network-controlled lock, in some cases), maybe used to lock other personal mobility devices, including, but not limited to: wheelchairs, tricycles, scooters, skateboards, longboards, e-bikes, motor-powered scooters, or any other similar means of personal transportation, mechanized or otherwise.

Embodiments include one, more, or any combination of the various apparatus and methods described herein. Other features and advantages of the present disclosure will become apparent from the following more detailed description, taken in conjunction with the accompanying, which illustrate, by way of example, the principles of the disclosure.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all possible modifications, equivalents, and alternatives falling within the scope of the disclosure as defined by the appended claims. In some aspects, the techniques described herein relate to a network-controlled bicycle lock for securing a bicycle to a bicycle rack including: a retrofit unit, configured to fasten a lock housing to the bicycle rack; and a tethering device configured to communicate the bicycle to the lock housing.

### BRIEF DESCRIPTION OF THE DRAWINGS

FIG. 1 illustrates a perspective view of a bike lock attached to a bike rack and bike, according to embodiments of the present disclosure.

FIG. 2 illustrates a perspective view of a network-controlled bicycle lock, according to embodiments of the present disclosure.

FIG. 3 illustrates a perspective view of a network-controlled bicycle lock, according to embodiments of the present disclosure.

FIG. 4 illustrates a perspective view of a network-controlled bicycle lock, according to embodiments of the present disclosure.

FIG. 5 illustrates a perspective view of a network-controlled bicycle lock, according to embodiments of the present disclosure.

FIG. 6 illustrates a perspective view of a network-controlled bicycle lock, according to embodiments of the present disclosure.

FIG. 7a illustrates a perspective view of a network-controlled bicycle lock, according to embodiments of the present disclosure.

FIG. 7b illustrates a perspective view of a network-controlled bicycle lock, according to embodiments of the present disclosure.

FIG. 8a illustrates a perspective view of a network-controlled bicycle lock, according to embodiments of the present disclosure.

FIG. 8b illustrates a perspective view of a network-controlled bicycle lock, according to embodiments of the present disclosure.

FIG. 9 illustrates a perspective view of a network-controlled bicycle lock, according to embodiments of the present disclosure.

FIG. 10 illustrates a flow diagram of a method of operating a network-controlled bicycle lock according to embodiments of the present disclosure.

FIG. 11 illustrates a flow diagram of a method of operating a network-controlled bicycle lock according to embodiments of the present disclosure.

FIG. 12 illustrates a flow diagram of a method of operating a network-controlled bicycle lock according to embodiments of the present disclosure.

Corresponding reference characters indicate corresponding parts throughout the several views.

While the disclosure is amendable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The following detailed description illustrates embodiments of the disclosure and manners by which they can be implemented. Although the best mode of carrying out the present disclosure has been disclosed, those skilled in the art would recognize that other embodiments for carrying out or practicing the present disclosure are also possible.

It should be noted that the terms “first,” “second,” and the like, herein do not denote any order, quantity, or importance, but rather are used to distinguish one element from another. Further, the terms “a” and “an” herein do not denote a limitation of quantity, but rather denote the presence of at least one of the referenced item.

Embodiments of the present disclosure provide individuals the ability to lock and unlock bicycles without needing to own a network-controlled bicycle lock. The network-controlled bicycle locks provided herein can be mounted to existing bicycle racks on or near buildings such as a railing, or gate, or some cases wooden structures, including trees. These network-controlled bicycle locks can be connected to a network such as but not limited to: Bluetooth, WiFi, NFC, and/or other RF course. Additionally, such network-controlled locks can include a retrofit unit that can connect the lock to an existing structure, a locking mechanism, some sort of flexible tether, chain, cable, and/or metal shape such as, but not limited: to a U-bolt shape, a hinged design; and or some combination thereof.

The locking mechanism of the network-controlled bicycle lock may be any type of electronic lock, including but not limited to: electromagnetic locks, electronic strikes, electronic deadbolts and latches, passive electronic locks, and/or a programmable lock.

Embodiments of the present disclosure relate to a bike security system or network-controlled bicycle lock which offers a cutting-edge solution for bike owners seeking a secure and convenient way to lock their bikes. The network-controlled bicycle lock is configurable to retrofit existing bike racks and features a tamper-resistant housing that protects the electrical components from inclement weather and vandalism. The network-controlled bicycle lock can be app-enabled, and can feature a sleeved chain that is highly resistant to cutting and tampering, ensuring maximum security for the bike owner. The network-controlled bicycle lock can incorporate a universal mounting bracket, a solar panel and battery reserve for power, and an app-less entry feature that allows users to lock and unlock their bikes without having to install a network-connected application on their smartphones. Furthermore, the network-controlled bicycle lock system can include an audible alarm on the rack, which sounds if tampering is detected, and a push notification system that alerts the user's cell phone if tampering is detected, enabling them to take immediate action and prevent theft.

The network-controlled bicycle lock provided herein are electromechanical devices that may be locked or unlocked in a purely mechanical fashion, while it is also contemplated that the devices may be locked or unlocked via electronic command received via a wireless protocol, such as Wi-Fi, Bluetooth, or near field communication (NFC), and/or other radio frequency (RF) or wireless protocol, via a mobile device. The network-controlled bicycle lock may then be connected with a wireless communications hub, which may connect to larger network, such as the internet. Such as configuration allows a user to control lock/unlock access of the bile lock remotely using the mobile device.

The network-controlled bicycle lock provided herein provides bike owners with a highly secure and convenient way to protect their bicycles from theft. The network-controlled bicycle lock can be configured to retrofit to existing bike racks and may include a tamper-resistant housing that protects the electrical components from inclement weather and vandalism. The lock housing 102 may be made of metal, fiber reinforced polymer, an/or ceramics, or a combination thereof. Additionally, components may be forged, cast, 3D-printed, and/or otherwise formed, and ma be assembled using any combination of mechanical, fasteners, mating features, welding, adhesives, and/or other known securement techniques.

Additionally, in some embodiments, the locking mechanism of the network-controlled bicycle may be delivered via a lock command from a network signal, and cause a motor to actuate and drive a locking sequence.

The network-controlled bicycle lock has a tethering device, that may include sleeved steel chain. The sleeve may comprise of a flexible cut-resistant material, such as aromatic polyamide fibers, poly-diamine fibers, or composites thereof. The network-controlled bicycle lock may a universal retrofit mounting bracket, a solar panel and battery reserve for power, and an app-less entry feature that allows users to lock and unlock the network-controlled lock, such as NFC or RFID.

Additionally, the network-controlled bicycle lock can include a proximity-based advertising feature that allows advertisers to offer geographically targeted or time-sensitive promotional discounts and advertisements to users when they come in close physical proximity to the lock.

It is contemplated that embodiments of the present disclosure can be made of materials an ordinary person of skill in the art would select. By way of example only, the various components of the network-controlled bicycle lock can be made of metal, polymer, fiber-reinforced composites, ceramics, fabrics, and or any combinations thereof.

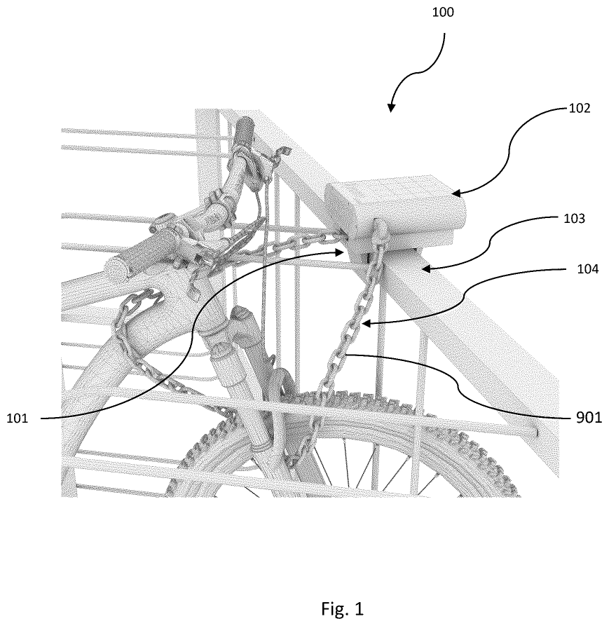

As Shown in FIG. 1 in some aspects, the techniques described herein relate to a network-controlled bicycle lock 100 for securing a bicycle to a bicycle rack 103 including: a retrofit unit 101, configured to fasten a lock housing 102 to the bicycle rack 103; and a tethering device 104 configured to communicate the bicycle to the lock housing 102.

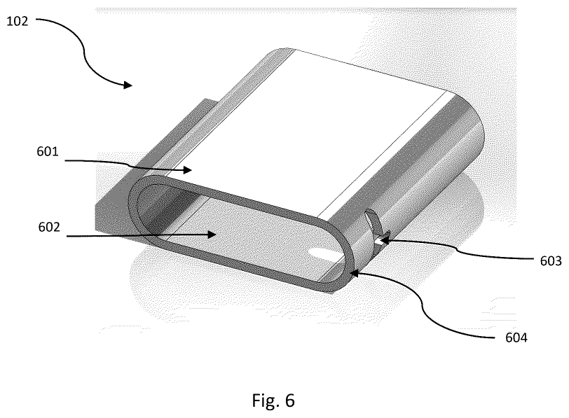

As Shown in FIG. 6 in some aspects, the techniques described herein relate to a network-controlled bicycle lock 100, wherein the lock housing 102 includes a housing surface 601 of hard, rigid material, and a housing interior 602 configured to communicate to the housing surface 601 via a lock aperture 603 configured to receive at least a portion of the tethering device 104.

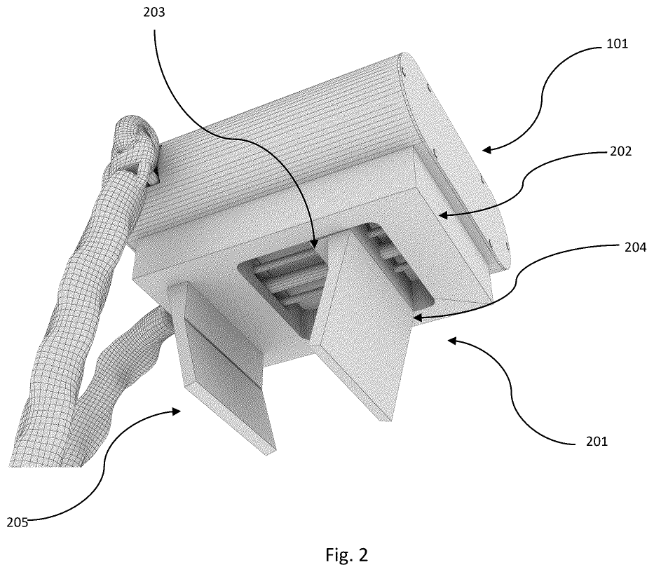

As shown in FIG. 2 in some aspects, the techniques described herein relate to a network-controlled bicycle lock 100, wherein the retrofit unit 101 includes a rail clamp 201 including: a base 202, a slide 203, a slide arm 204, and a fixed arm 205; wherein the base 202 is configured to accommodate the slide 203 and fixedly connect to the fixed arm 205; and the slide 203 is configured to fixedly connect to the slide arm 204.

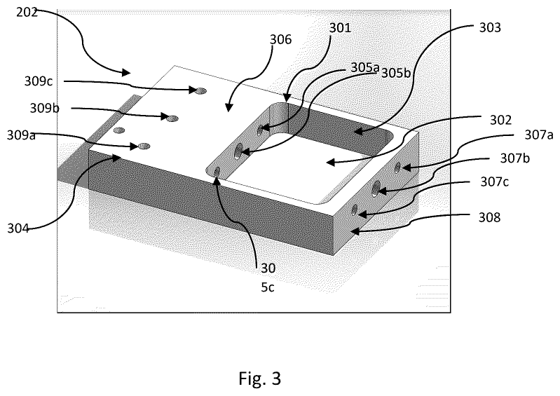

As shown in FIG. 3 in some aspects, the techniques described herein relate to a network-controlled bicycle lock 100, wherein the base 202 further includes: a slide inset 301 having an inset base 302 and an inset wall 303 configured to accommodate the slide 203, and a fixed surface 304 configured to accommodate the fixed arm 205; wherein the inset wall 303 includes at a first set of apertures 305a, 305b, 305c configured to communicate the slide inset 301 to an anchor portion 306, and a second set of apertures 307 configured to communicate the slide inset 301 to an outer surface 308 of the rail clamp 201, and the fixed surface 304 further includes at least three fixed arm apertures 309a, 309b, 309c configured to communicate with the fixed arm 205.

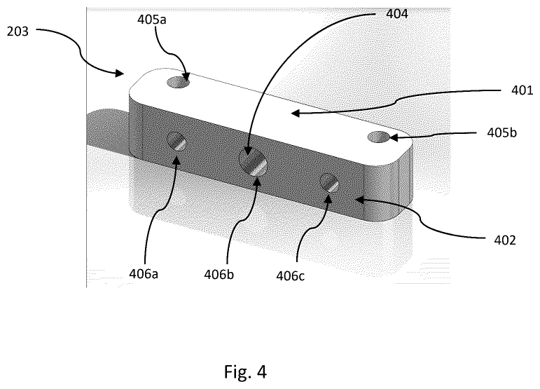

As shown in FIG. 4 in some aspects, the techniques described herein relate to a network-controlled bicycle lock 100, wherein the slide 203 further includes: a slide top 401, a slide wall 402, a slide interior 404, at least two slide arm apertures 405a, 405b configured to fixedly accommodate the slide arm 204; and a plurality of slide apertures 406a, 406b, 406c that communicate the slide wall 402 entirely though the slide interior 404; wherein the plurality of slide apertures 406a, 406b, 406c comprises: two rod apertures 406a, 406c configured to each accommodate a slide rod 206a, 206b, and a screw aperture 406b configured to communicate with an adjustable screw 207.

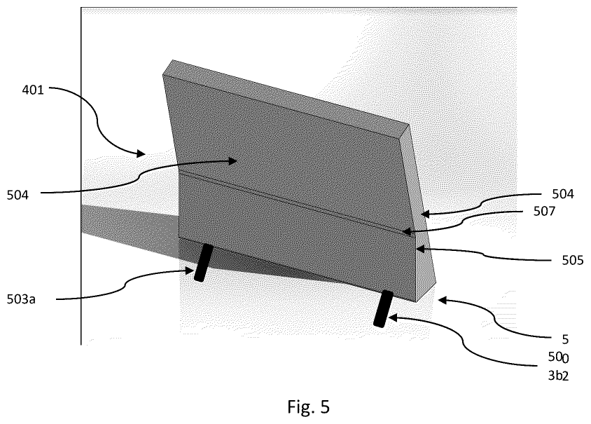

As shown in FIG. 5 in some aspects, the techniques described herein relate to a network-controlled bicycle lock 100, wherein the slide arm 204 and the fixed arm 205 are each included of a rail clamp arm 501 including: a clamp arm base 502 configured to accommodate a plurality of clamp arm studs 503a, 503b, a clamp profile 504 having a convex portion 505 configured to accommodate the bicycle rack 103, and a clamping surface 506 having a convex surface 507, wherein the convex surface 507 is configured to accommodate the bicycle rack 103.

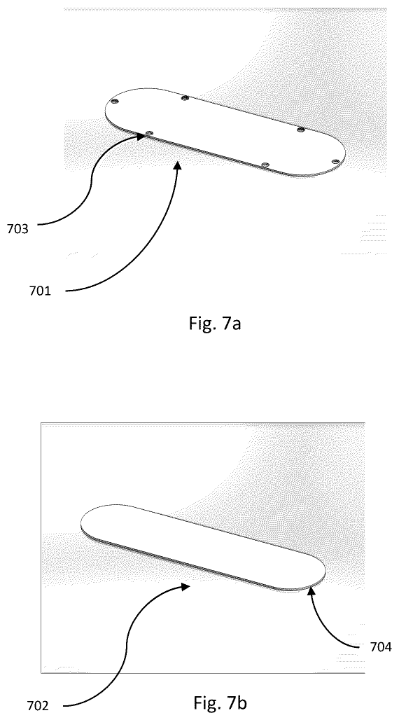

As shown in FIG. 7a and FIG. 7b, in some aspects, the techniques described herein relate to a network-controlled bicycle lock 100, wherein the lock housing 102 further includes: a housing back plate 701 that has a back profile 703, a housing inner plate 702 that has an inner profile 704, and a housing profile 604, wherein the back profile 703 and the inner profile 704 are configured to communicate with the housing profile 604 of the lock housing 102.

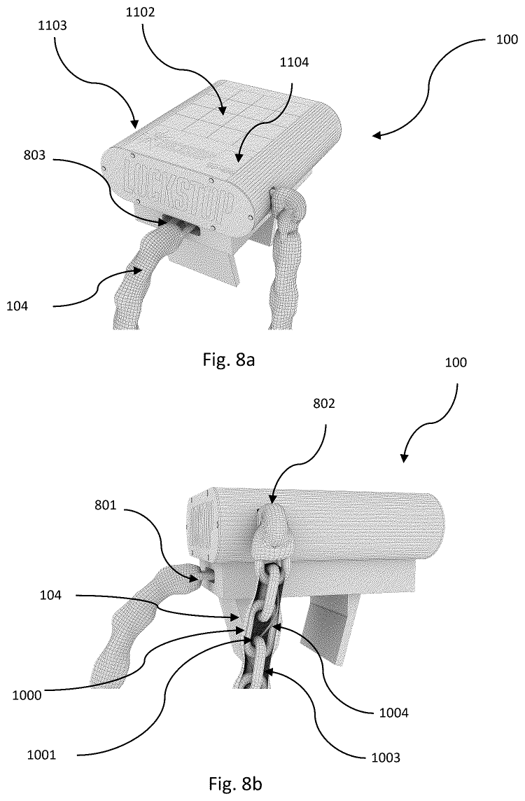

As shown in FIG. 8a and FIG. 8b, in some aspects, the techniques described herein relate to a network-controlled bicycle lock 100, wherein the tethering device 104 further includes an anchoring end 801 and a locking end 802, wherein the locking end 802 is configured to communicate with the lock housing 102 and the anchoring end 801 to fixedly communicate with the base 202.

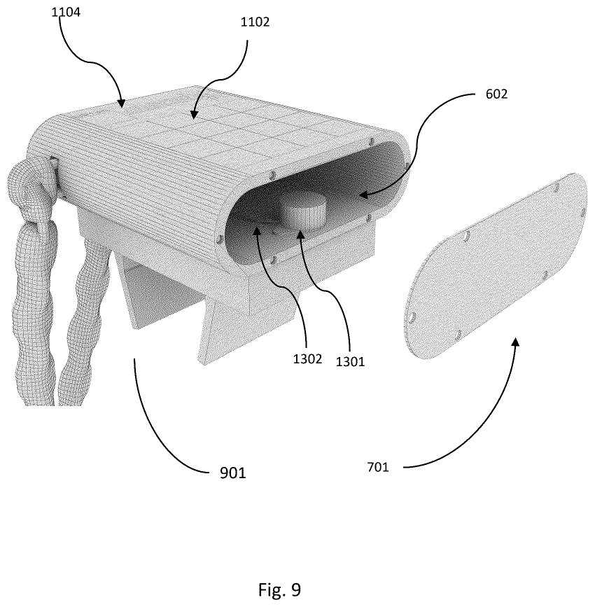

As shown in FIGS. 1-9, in some aspects, the techniques described herein relate to a network-controlled bicycle lock 100, wherein the base 202 further includes an anchor receiving portion 803 configured to integrate into a circuit 901, the circuit 901 including of the base 202, the lock housing 102, the circuit 901 being configured to communicate a signal between the base 202 and the lock housing 102.

As shown in FIGS. 1-9, in some aspects, the techniques described herein relate to a network-controlled bicycle lock 100, wherein the tethering device 104 further includes: an exterior 1000 and an interior 1001 of the tethering device 104, wherein the interior 1001 of the tethering device 104 includes a strength portion 1003 and a tamper sensor 1004, wherein the tamper sensor 1004 is configured to communicate with the lock housing 102, and the base 202; and is configured to align within the strength portion 1003.

As shown in FIG. 8b, in some aspects, the techniques described herein relate to a network-controlled bicycle lock 100, wherein the tamper sensor 1004 is including a conductor configured to conduct an electrical current, between the lock housing 102 and the base 202, wherein the conductor is further configured to be pressure sensitive.

As shown in FIGS. 8a-8b in some aspects, the techniques described herein relate to a network-controlled bicycle lock 100, wherein the lock housing 102 is further including a solar module 1101 configured to fixedly connect to a top portion 1102 of the lock housing 102, and the top portion 1102 of the lock housing 102 has a communication transmitter 1104.

As shown in FIGS. 1-9 in some aspects, the techniques described herein relate to a network-controlled bicycle lock 100 wherein the housing interior 602 of the lock housing 102 is configured to accommodate an adjustment element 1301 configured to communicate with an adjustable screw 207 and the slide 203 and the slide arm 204, wherein the adjustment element 1301 includes a step-down gear 1302 and is configured to communicate with the adjustable screw 207.

As shown in FIGS. 1-9 in some aspects, the techniques described herein relate to a network-controlled bicycle lock 100 wherein the adjustment element 1301 is further configured to have a disconnect module, wherein the disconnect module is configured to transmit a clamp signal.

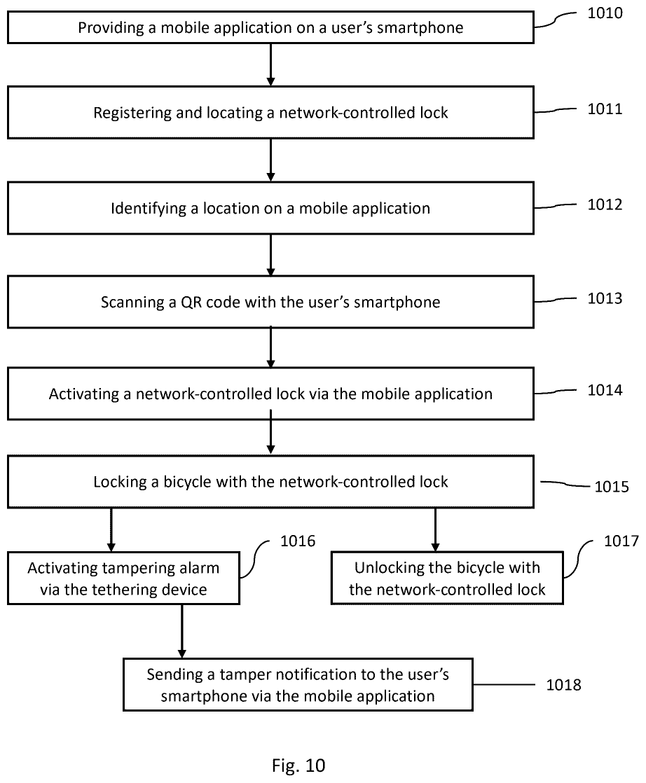

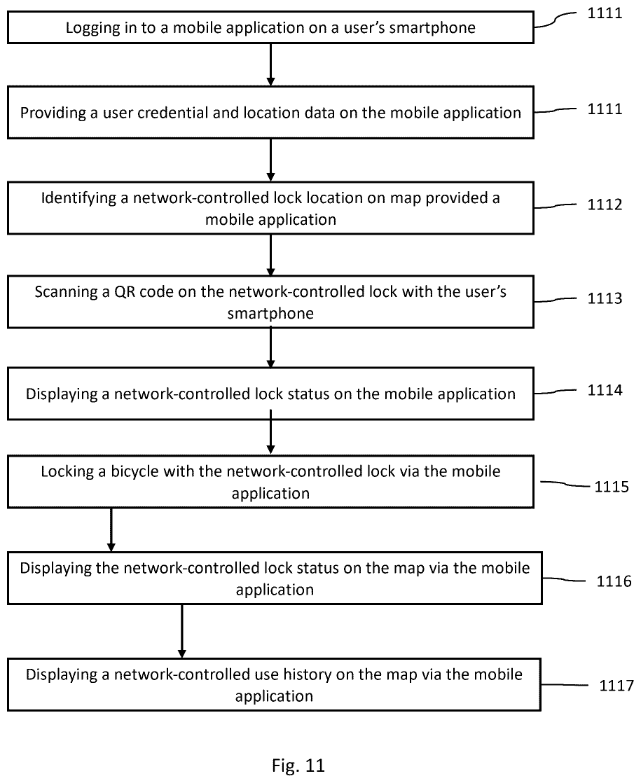

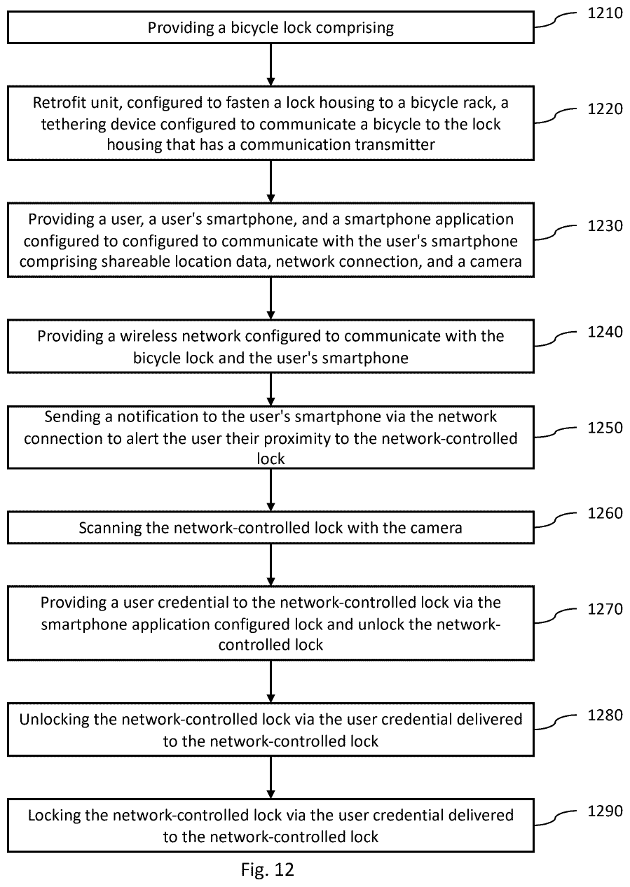

As shown in FIGS. 10-12 in some aspects, the techniques described herein relate to a method of using a network-controlled lock including: Providing a network-controlled network-controlled bicycle lock 1210 including: retrofit unit, configured to fasten a lock housing to a bicycle rack, a tethering device configured to communicate a bicycle to the lock housing that has a communication transmitter 1220; providing a user, a user's smartphone, and a smartphone application configured to configured to communicate with the user's smartphone including shareable location data, network connection, and a camera 1230; providing a wireless network configured to communicate with the network-controlled bicycle lock and the user's smartphone 1240; sending a notification to the user's smartphone via the network connection to alert the user their proximity to the network-controlled lock 1250; scanning the network-controlled lock with the camera 1260; providing a user credential to the network-controlled lock via the smartphone application configured lock and unlock the network-controlled lock 1270; unlocking the network-controlled lock via the user credential delivered to the network-controlled lock 1280; and locking the network-controlled lock via the user credential delivered to the network-controlled lock 1290.

In some aspects, the techniques described herein relate to a method further including: providing the communication transmitter that further includes a QR code; scanning the QR code on the communication transmitter with the camera; providing a network-connected application configured to communicate over the wireless network, wherein the network-connected application communicates with the network-controlled lock, selecting the network-controlled lock on the network-connected application via the user's smartphone, and connecting the user's smartphone to the network-controlled lock via the network connection.

As shown in FIGS. 10-12 in some aspects, the techniques described herein relate to a method, further including: displaying a map to the user's smartphone on the network-connected application, displaying a location on the map of the network-controlled lock on the user's smartphone via the network-connected application, and displaying a lock status of the network-controlled lock to on the user's smartphone via the network-connected application.

As shown in FIGS. 10-12 in some aspects, the techniques described herein relate to a method, further including; providing an of advertisement database including advertisements that each have a location marker, on the network-connected application, identifying a location user's smartphone based on the shareable location data, comparing the location the advertisements that each have a location marker, selecting advertisements from the advertisement database, and pushing a notification to the user's smartphone.

In some cases, embodiments herein disclosed include a time-based display condition, wherein identifying a location of a user's smartphone can be based on the location marker further including physical location history, time and date data collected from the user's mobile device. In some case, advertisements may be selected based upon the time-based display location, wherein advertisements delivered to the user's mobile device can be selected or chosen based on the user's time-based display condition. By way of example only, the mobile application may deliver limited time offers or advertisements based on the location history of a user's mobile device, such as time-limited discounts, local-resident discounts, or loyalty discounts or compounds.

As shown in FIGS. 10-12 in some aspects, the techniques described herein relate to a method, further including: providing a time-remaining clock, and a payment system configured to be displayed on the network-connected application, displaying the time-remaining clock on the network-connected application, and displaying a cost to the user's smartphone based on the time-remaining clock, location data, and the location of the network-controlled lock.

As shown in FIGS. 10-12 in some aspects, the techniques described herein relate to a method, further including: providing a tamper sensor configured to communicate with the network-connected application via the wireless network, and delivering a tamper signal to the user's smartphone based on the tamper sensor.

In some embodiments, the techniques herein include a proximity-based advertisement system, wherein the user with a network-controlled lock mobile application installed on their phone or mobile device, can enable push notifications. In such cases, the user can receive proximity-based advertisements on their mobile device. The mobile application can be installed on a mobile device, such as a smartphone, tablet, smartwatch, or any other network-enabled device. In such cases where the user enables proximity-based advertisements, it is contemplated that a payment system included in the mobile application would discount a usage rate of the network-controlled lock.

By way of example, according to some embodiments, a user with the proximity-based advertisement notifications enabled would receive one or more notifications on their mobile device or the lock display for advertisements that are based on location data of the mobile device in comparison with the location of a particular network-controlled lock. In some cases, a particular network-controlled lock can have advertisements assigned to the lock, and when a user with the mobile application enabled on their mobile device physically enter a pre-defined location, or proximity to the particular network-controlled lock, the mobile application delivers the proximity-based advertising to the user's mobile device. In some cases, after the proximity-based advertisement is delivered to the user's mobile device, the mobile application can approve and/or distribute a discount to the user to enable the free or discounted use of a network-controlled lock.

It is also contemplated, according to embodiments disclosed herein, that the mobile application may send notifications to a user's mobile device or smartphone based on historic geo-location data, or shareable location data, on the user's mobile device. In such cases, the mobile application may deliver a limited-time advertisement or discount

The methods, systems, and devices discussed above are examples. Some embodiments were described as processes depicted as flow diagrams or block diagrams. Although each may describe the operations as a sequential process, many of the operations can be performed in parallel or concurrently. In addition, the order of operations may be rearranged. A process may have additional steps not included in the figures. Furthermore, embodiments of the methods may be implemented by hardware, software, firmware, middleware, microcode, hardware descriptions languages, or any combination thereof. When implemented in software, firmware, middleware, or microcode, the program code or code segments to perform the associated tasks may be stored in a computer-readable medium such as a storage medium. Processors may perform the associated tasks.

It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should be interpreted to limit the scope of the claimed embodiments.

Specific details are given in the description to provide a thorough understanding of the embodiments. However, it will be understood by one having ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the inventions. Rather, the preceding description of the embodiments will provide those skilled in the art with an enabling description for implementing various embodiments disclosed herein. Various changes may be made in the function and arrangements of elements without departing from the spirit and scope of the invention.

Having described several embodiments, it will be recognized by those of skill in the art that various modifications, alternative constructions, and equivalents may be used without departing from the spirit of the embodiments disclosed herein. For example, the above elements may merely be a component of a larger system, wherein other rules may take precedence over or otherwise modify the application of the embodiments disclosed herein. Also, a number of steps may be undertaken before, during, or after the above elements are considered. Accordingly, the above description should not be taken as limiting the scope of the embodiments disclosed herein.

What is claimed is:

1. A network-controlled bicycle lock for securing a bicycle to a bicycle rack comprising:
a retrofit unit, configured to fasten a lock housing to the bicycle rack; and
a tethering device configured to communicate the bicycle to the lock housing.

2. The network-controlled bicycle lock of claim 1, wherein the lock housing comprises a housing surface of hard, rigid material, and a housing interior configured to communicate to the housing surface via a lock aperture configured to receive at least a portion of the tethering device.

3. The network-controlled bicycle lock of claim 2, wherein the retrofit unit comprises a rail clamp comprising:
a base,
a slide,
a slide arm, and
a fixed arm;
wherein the base is configured to accommodate the slide and fixedly connect to the fixed arm; and the slide is configured to fixedly connect to the slide arm.

4. The network-controlled bicycle lock of claim 3, wherein the base further comprises:
a slide inset having an inset base and an inset wall configured to accommodate the slide, and
a fixed surface configured to accommodate the fixed arm;
wherein the inset wall comprises at a first set of apertures configured to communicate the slide inset to an anchor portion, and a second set of apertures configured to communicate the slide inset to an outer surface of the rail clamp, and the fixed surface further includes at least three fixed arm apertures configured to communicate with the fixed arm.

5. The network-controlled bicycle lock of claim 4, wherein the slide further includes:
a slide top, a slide wall, a slide interior, at least two slide arm apertures configured to fixedly accommodate the slide arm; and
a plurality of slide apertures that communicate the slide wall entirely though the slide interior;
wherein the plurality of slide apertures comprises: two rod apertures configured to each accommodate a slide rod, and a screw aperture configured to communicate with an adjustable screw.

6. The network-controlled bicycle lock of claim 5, wherein the slide arm and the fixed arm are each comprised of a rail clamp arm comprising:
a clamp arm base configured to accommodate a plurality of clamp arm studs,
a clamp profile having a convex portion configured to accommodate the bicycle rack, and
a clamping surface having a convex surface, wherein the convex surface is configured to accommodate the bicycle rack.

7. The network-controlled bicycle lock of claim 6, wherein the lock housing further comprises: a housing back plate that has a back profile, a housing inner plate that has an inner profile, and a housing profile, wherein the back profile and the inner profile are configured to communicate with the housing profile of the lock housing.

8. The network-controlled bicycle lock of claim 3, wherein the tethering device further includes an anchoring end and a locking end, wherein the locking end is configured to communicate with the lock housing and the anchoring end to fixedly communicate with the base.

9. The network-controlled bicycle lock of claim 8, wherein the base further comprises an anchor receiving portion configured to integrate into a circuit, the circuit comprising of the base, the lock housing, the circuit being configured to communicate a signal between the base and the lock housing.

10. The network-controlled bicycle lock of claim 9, wherein the tethering device further includes: an exterior and an interior of the tethering device, wherein the interior of the tethering device comprises a strength portion and a tamper sensor, wherein the tamper sensor is configured to communicate with the lock housing, and the base; and is configured to align within the strength portion.

11. The network-controlled bicycle lock of claim 10, wherein the tamper sensor is comprising a conductor configured to conduct an electrical current, between the lock housing and the base, wherein the conductor is further configured to be pressure sensitive.

12. The network-controlled bicycle lock of claim 11, wherein the lock housing is further comprising a solar module configured to fixedly connect to a top portion of the lock housing, and the top portion of the lock housing has a communication transmitter.

13. The network-controlled bicycle lock of claim 7 wherein the housing interior of the lock housing is configured to accommodate an adjustment element configured to communicate with a screw and the slide and the slide arm, wherein the adjustment element comprises a step-down gear and is configured to communicate with the screw.

14. The network-controlled bicycle lock of claim 13 wherein the adjustment element is further configured to have a disconnect module, wherein the disconnect module is configured to transmit a clamp signal.

15. A method of using a network-controlled lock comprising:
Providing a network-controlled bicycle lock comprising:
retrofit unit, configured to fasten a lock housing to a bicycle rack, a tethering device configured to communicate a bicycle to the lock housing that has a communication transmitter;
providing a user, a user's smartphone, and a smartphone application configured to configured to communicate with the user's smartphone comprising shareable location data, network connection, and a camera;
providing a wireless network configured to communicate with the network-controlled bicycle lock and the user's smartphone;
sending a notification to the user's smartphone via the network connection to alert the user their proximity to the network-controlled lock;
scanning the network-controlled lock with the camera;
providing a user credential to the network-controlled lock via the smartphone application configured lock and unlock the network-controlled lock;
unlocking the network-controlled lock via the user credential delivered to the network-controlled lock; and
locking the network-controlled lock via the user credential delivered to the network-controlled lock.

16. The method of claim 15 further comprising:
providing the communication transmitter that further comprises a QR code;
scanning the QR code on the communication transmitter with the camera;
providing a network-connected application configured to communicate over the wireless network, wherein the network-connected application communicates with the network-controlled lock,
selecting the network-controlled lock on the network-connected application via the user's smartphone, and
connecting the user's smartphone to the network-controlled lock via the network connection.

17. The method of claim 16, further comprising:
displaying a map to the user's smartphone on the network-connected application,
displaying a location on the map of the network-controlled lock on the user's smartphone via the network-connected application, and
displaying a lock status of the network-controlled lock to on the user's smartphone via the network-connected application.

18. The method of claim 17, further comprising;
providing an of advertisement database comprising advertisements that each have a location marker, on the network-connected application,
identifying a location user's smartphone based on the shareable location data,
comparing the location the advertisements that each have a location marker,
selecting advertisements from the advertisement database, and
pushing a notification to the user's smartphone.

19. The method of claim 18, further comprising:
providing a time-remaining clock, and a payment system configured to be displayed on the network-connected application,
displaying the time-remaining clock on the network-connected application, and
displaying a cost to the user's smartphone based on the time-remaining clock, location data, and the location of the network-controlled lock.

20. The method of claim 16, further comprising:
providing a tamper sensor configured to communicate with the network-connected application via the wireless network, and
delivering a tamper signal to the user's smartphone based on the tamper sensor.
